(19) United States
(12) Patent Application Publication
(10) Pub. No.: US 2023/0367979 A1
(43) Pub. Date: Nov. 16, 2023

(54) QR Code Application Device

(71) Applicant: Rory James, Riverdale, GA (US)

(72) Inventor: Rory James, Riverdale, GA (US)

(21) Appl. No.: 18/315,173

(22) Filed: May 10, 2023

Related U.S. Application Data
(60) Provisional application No. 63/340,039, filed on May 10, 2022.

(51) Int. Cl. G06K 1/12

(52) U.S. Cl. CPC G06K 1/121

(57) ABSTRACT

A QR code application device is disclosed which is a specialized QR code-based smartphone application that helps incentivize service industry employees to uphold good customer service. The QR codes will be printed on cups, napkins, containers, etc., and the customer can scan the QR code to tip the employee that served them. Each employee can create a profile on the application, which is then linked to an individual QR code. Thus, users can tip the specific employee through third-party payment programs via the QR code.

### CROSS-REFERENCE TO RELATED APPLICATION

The present application claims priority to, and the benefit of, U.S. Provisional Application No. 63/340,039, which was filed on May 10, 2022, and is incorporated herein by reference in its entirety.

### FIELD OF THE INVENTION

The present invention relates generally to the field of QR code application devices. More specifically, the present invention relates to a QR code-based smartphone application that helps customer service employees earn tips. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in QR code application devices. Generally, people working in customer service-based jobs may not be encouraged enough to provide great service. Employers will inevitably miss out on sales if their employees are not motivated to offer great customer service to people. People may be looking for easier ways to tip workers rather than handing them cash.

In many service-based industries, it is common to tip. In many cases, such as when dining or receiving a spa treatment, the service is provided in conjunction with a bill. In these cases, it is easy to add the tip to the payment of the bill using a credit or debit card. In other cases, such as with a concierge or valet, the service may be provided separate from any bill. In these cases, the tip is typically paid with cash. Unfortunately, many people do not carry sufficient cash to tip individuals a desirable amount. As a result, people often feel badly that they cannot tip more.

Accordingly, there is a demand for a QR code application device that allows QR codes to be printed on various items, for a customer to scan and send a tip to the employee. More particularly, the QR code application device encourages employees to provide great customer service to earn tips and increase business.

Therefore, there exists a long-felt need in the art for a QR code application device that provides users with a QR code-based smartphone application that helps customer service employees earn tips. There is also a long-felt need in the art for a QR code application device that allows QR codes to be printed on different items like cups, napkins, containers, etc., for a customer to scan and send a tip to the employee that served them. Further, there is a long-felt need in the art for a QR code application device that encourages employees to provide great customer service to earn tips and increase sales for a business. Moreover, there is a long-felt need in the art for a device that offers a way for employees to earn extra money at their fast food and retail store jobs. Further, there is a long-felt need in the art for a QR code application device that allows each employee to create a profile on the application which is tied to the QR codes. Finally, there is a long-felt need in the art for a QR code application device that allow users to tip for all services received.

The subject matter disclosed and claimed herein, in one embodiment thereof, comprises a QR code application device. The device is a specialized QR code-based smartphone application that helps incentivize service industry employees to uphold good customer service. The QR codes will be printed on cups, napkins, containers, etc., and the customer can scan the QR code to tip the employee that served them. Each employee can create a profile on the application, which is then linked to an individual QR code. Thus, users can tip the specific employee through third-party payment programs via the QR code.

In this manner, the QR code application device of the present invention accomplishes all of the foregoing objectives and provides users with a device that allows users to scan a QR code to tip an employee. The device is a specific QR code for each employee that can be printed on various items. The device encourages employees to provide great customer service to earn tips.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a QR code application device. The device is a specialized QR code-based smartphone application that helps incentivize service industry employees to uphold good customer service. The QR codes will be printed on cups, napkins, containers, etc., and the customer can scan the QR code to tip the employee that served them. Each employee can create a profile on the application, which is then linked to an individual QR code. Thus, users can tip the specific employee through third-party payment programs via the QR code.

The present invention extends to methods, systems, and QR code application devices for tipping an individual using a smartphone or other mobile computing device. A smartphone can be configured with an application that scans a QR code that can be placed on a specific item, such as a cup, a napkin, a container, a nametag, etc. The QR code can uniquely identify the service individual including the service individual's account. The application can also be configured with the user's payment account information to enable the application to initiate the transfer of a tip from the user's payment account to the service individual's account when the QR code is scanned. Accordingly, the user only needs to scan the QR code to provide a tip to the service individual. In this way, a tip of virtually any amount can be provided quickly and easily even when the user does not have any cash.

A “quick response” code or “QR code” may be a matrix barcode and a type of machine-readable code that contains information (i.e., information pertaining to a payment transaction). A typical QR code may use four standardized encoding modes (numeric, alphanumeric, byte/binary, and kanji) to efficiently store data.

As explained above, QR codes can encode financial transaction data and other transaction security data. A QR code can be used to initiate transaction activity. Two-way communication using QR codes can also improve transaction security.

In one embodiment, the QR code application device allows a user to provide a tip electronically using a mobile computing device. Specifically, a mobile computing device of a user is used to scan a QR code that is associated with an account of a service individual. The mobile computing device displays, to the user of the mobile computing device, an interface for receiving a tip amount to provide to the service individual for services rendered by the individual to the user. The tip amount is then received from the user. The QR code and the tip amount are transferred to a server system to request the transfer of the tip amount from a user's account to the service individual's account that is associated with the QR code.

In another embodiment, the tip amount is transferred from a user's account to an account of a service individual using a QR code associated with the service individual. Account information for a service individual's account is received. Information identifying the service individual is also received. An association between a QR code and the service individual's account is generated. The QR code is provided to the service individual to allow the service individual to display the QR code to a user to whom the individual provides services. Once the user scans the QR code using a portable computing device, the QR code is received along with a tip amount to transfer from a user's account to the service individual's account. Then, the tip amount is transferred to the service individual's account.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Further, computer storage media (devices) include RAM, ROM, EEPROM, CD-ROM, solid state drives (“SSDs”) (i.e., based on RAM), flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, etc.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

In one embodiment, a service individual wears a name badge or carries a coffee cup that includes a two-dimensional barcode (or QR code). Other types of scannable codes could also be used in the same manner as the QR code. The QR code is uniquely associated with the service individual. More specifically, the QR code can uniquely identify a bank account of the service individual. In this manner, by scanning the QR code, an application executing on a smartphone can retrieve the necessary information for transferring a tip from a user's account to the service individual's bank account.

In some embodiments, a database of QR codes can be maintained (i.e., on a server system with which a smartphone can communicate). Each of the QR codes in the database can be associated with a unique individual. The database can also store account information for each of the individuals. In such cases, when a user scans a QR code with a smartphone, an application on the smartphone can access the database to identify whether the QR code is defined in the database. If the QR code is defined in the database, the account information associated with the QR code can be used to initiate the transfer of a tip from the user's account to the account associated with the QR code.

In one embodiment, each QR code represents a unique identifier. When the QR code is scanned, the unique identifier for the QR code can be determined and used to query a data structure to obtain the account information associated with the QR code. Once obtained, the account information can be used to transfer a tip from the user's account to the account associated with the scanned QR code.

Accordingly, the present invention enables any service individual to receive tips electronically by simply wearing or providing access to a QR code that has been associated with the service individual and the service individual's bank account (or other similar account). In some embodiments, the present invention can provide a website or other application where a service individual can input his/her account information to receive a QR code that can be used to receive tips. For example, in response to receiving a service individual's account information (i.e., bank account and routing number), the application can generate an association between the account information and a QR code. The associated QR code can then be provided to the service individual. For example, the QR code can be displayed to allow the service individual to print it. In some embodiments, the QR code can be printed as a sticker that can be adhered to a service individual's name badge, coffee cup, napkin, or other item. In this way, the QR code will be visible to users whom the service individual assists thereby informing the users that the service individual accepts tips electronically.

In some embodiments, the present invention can also store account information for users that may use their smartphones to tip an individual. For example, a user can input his bank account information or credit or debit card number which can then be stored for automatic retrieval when the user scans a QR code. In this manner, the user does not need to input this information when providing a tip. In some embodiments, the user can also input a default tip amount so that when a QR code is scanned, the default amount can automatically be transferred without requiring any input from the user. In other embodiments, after scanning a QR code, the user can be presented with the option to specify or select an amount to tip.

In one embodiment, an example computer environment includes a mobile computing device which may typically be a smartphone having a camera with which a QR code can be scanned. The mobile computing device is interconnected via a network with multiple server systems. The server systems can represent the systems where a user's and a service individual's account information is stored as well as possibly other systems that are employed to perform a transfer of funds between accounts.

The specific manner in which funds are transferred between two accounts is not essential to the invention. The network typically will be the internet although other networks can also be employed. For example, in a typical implementation, the mobile computing device will communicate with one or more of the server systems using a Wi-Fi or cellular (i.e., 4G) connection. Also, although this specification will primarily refer to using a smartphone to tip an individual, any mobile computing device capable of performing the described functionality could also be used (i.e., a tablet).

In one embodiment, a process of creating an association between a QR code and a service individual's account information and then using this association to transfer a tip to the service individual's account is disclosed.

A service individual desiring to receive a QR code inputs their account information. Account information can include a bank account number and a routing number as well as any other information necessary to transfer funds to the service individual's account. Additional information can also be input such as the service individual's name, work location, work title, picture, etc. Such information can be useful for providing an interface such as user interface when a QR code is scanned. The user computing system can represent any device that a user can employ to provide information to server system. For example, the user computing system can be a smartphone having a custom app or a web browser that receives a service individual's account information or a desktop, laptop, tablet, or other computer that employs a browser or other application for receiving the account information.

Once the account information is input to a user computing system, the account information can then be sent to a server system. The QR code can then be generated/associated with the account information. Once the service individual receives the QR code, it can be displayed (i.e., electronically or by printing the QR code) where users can view and scan it to provide a tip. Accordingly, a user scans the QR code using a smartphone and inputs a tip amount. The scanned QR code, as well as the tip amount, are transmitted to a server system. Then, the tip amount can be transmitted to the server system. The QR code is then used to retrieve the appropriate account information. Finally, the account information is used to initiate the transfer of the tip amount from the user's account to the account associated with the scanned QR code.

Accordingly, the present invention provides a simple manner for providing a tip to a service individual. The present invention would require the service individual to wear (or otherwise present) a scannable QR code. The users would then be tasked with scanning the QR code and completing the tip transaction. The simplicity of the system is therefore ideal for use by a service individual who may not be able to take the time to process a transaction after performing each service, while also minimizing the steps required of the user to provide the tip.

In yet another embodiment, the QR code application device comprises a plurality of indicia.

In yet another embodiment, a method of utilizing a QR code to tip an employee after service is disclosed. The method includes the steps of providing a QR code application device comprising a QR code that is printed on specific items, such as cups, napkins, containers, etc. The method also comprises creating an employee profile on the application with banking details. Further, the method comprises linking the employee profile to a specific QR code. Finally, the method comprises scanning the QR code on the specific item and tipping a specific employee through a third-party payment program via the QR code.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the QR code application device of the present invention in use in accordance with the disclosed architecture;

FIG. 2 illustrates a perspective view of one embodiment of the QR code application device of the present invention showing the QR code applied to a napkin in accordance with the disclosed architecture;

FIG. 3 illustrates a perspective view of one embodiment of the QR code application device of the present invention showing the QR code applied to a coffee cup in accordance with the disclosed architecture;

FIG. 4 illustrates a perspective view of one embodiment of the QR code application device of the present invention showing the computer environment for the QR code application in accordance with the disclosed architecture;

FIG. 5 illustrates a flowchart of one embodiment of the process of utilizing the QR code application device in accordance with the disclosed architecture; and

FIG. 6 illustrates a flowchart showing the method of utilizing a QR code to tip an employee after service in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a QR code application device that provides users with a QR code-based smartphone application that helps customer service employees earn tips. There is also a long-felt need in the art for a QR code application device that allows QR codes to be printed on different items like cups, napkins, containers, etc., for a customer to scan and send a tip to the employee that served them. Further, there is a long-felt need in the art for a QR code application device that encourages employees to provide great customer service to earn tips and increase sales for a business. Moreover, there is a long-felt need in the art for a device that offers a way for employees to earn extra money at their fast food and retail store jobs. Further, there is a long-felt need in the art for a QR code application device that allows each employee to create a profile on the application which is tied to a QR code. Finally, there is a long-felt need in the art for a QR code application device that allow users to tip for all services received.

The present invention, in one exemplary embodiment, is a novel QR code application device. The device is a specialized QR code-based smartphone application that helps incentivize service industry employees to uphold good customer service. The QR codes will be printed on cups, napkins, containers, etc., and the customer can scan the QR code to tip the employee that served them. Each employee can create a profile on the application, which is then linked to an individual QR code. Thus, users can tip the specific employee through third-party payment programs via the QR code. The present invention also includes a novel method of utilizing a QR code to tip an employee after service. The method includes the steps of providing a QR code application device comprising a QR code that is printed on specific items, such as cups, napkins, containers, etc. The method also comprises creating an employee profile on the application with banking details. Further, the method comprises linking the employee profile to a specific QR code. Finally, the method comprises scanning the QR code on the specific item and tipping a specific employee through a third-party payment program via the QR code.

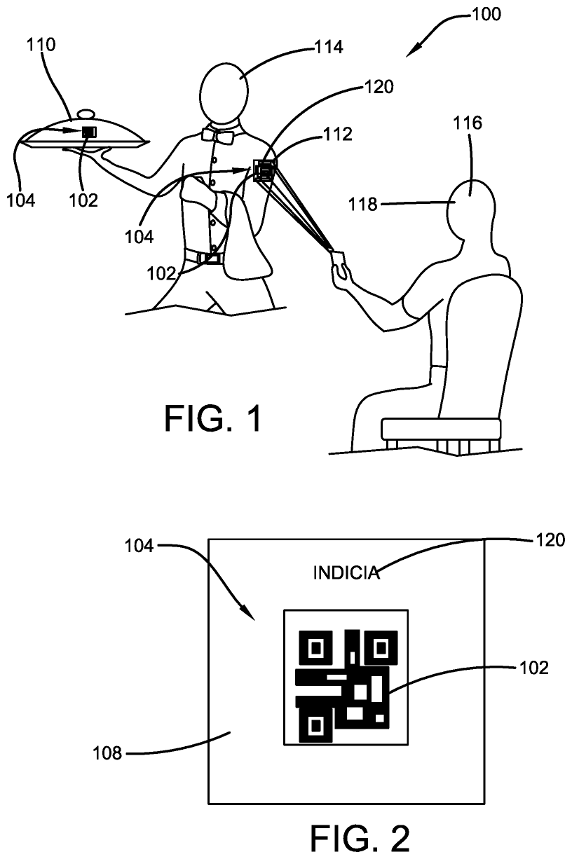

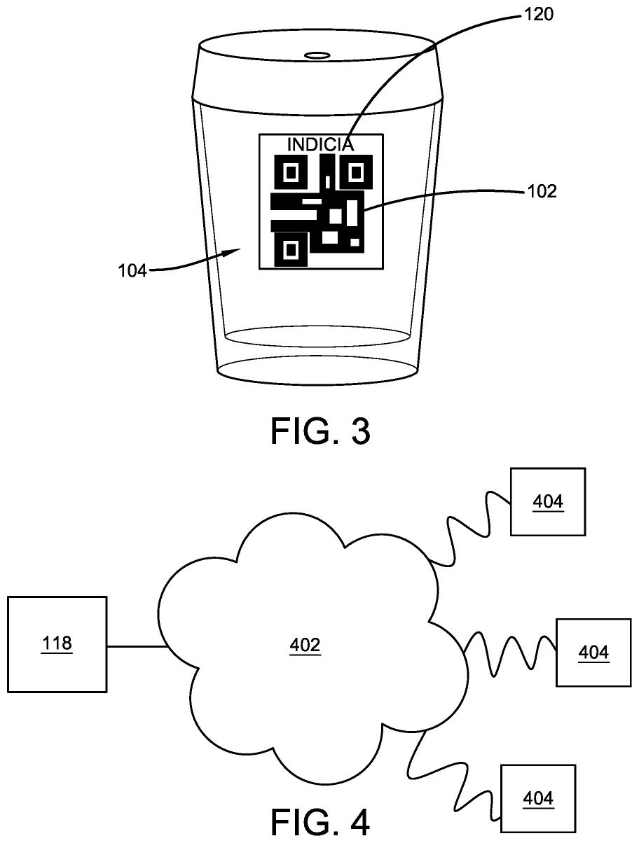

Referring initially to the drawings, FIGS. 1-3 illustrate a perspective view of one embodiment of the QR code application device 100 of the present invention. In the present embodiment, the QR code application device 100 is an improved QR code application device 100 that provides a user with a specialized QR code-based smartphone application that helps incentivize service industry employees to uphold good customer service. Specifically, the QR code application device 100 comprises a QR code 102 printed on a specific item 104, such as a cup 106, a napkin 108, a container 110, a nametag 112, etc., or any other suitable items as is known in the art. Each employee or service individual 114 can create a profile on the application device 100, which is then linked to an individual QR code 102. Thus, users 116 can tip the service individuals 114 which is then received by the specific service individual 114 through third-party payment programs via the QR codes 102 on the specific items 104.

The present invention extends to methods, systems, and QR code application devices 100 for tipping a service individual 114 using a smartphone 118 or other mobile computing device. A smartphone 118 can be configured with an application that scans a QR code 102 that can be placed on a specific item 104, such as a cup 106, a napkin 108, a container 110, a nametag 112, etc. The QR code 102 can uniquely identify the service individual 114 including the service individual's account. The application 100 can also be configured with the user's payment account information to enable the application 100 to initiate the transfer of a tip from the user's payment account to the service individual's account when the QR code 102 is scanned. Accordingly, the user 116 only needs to scan the QR code 102 to provide a tip to the service individual 114. In this way, a tip of virtually any amount can be provided quickly and easily even when the user 116 does not have any cash.

A “quick response” code or “QR code” 102 may be a matrix barcode and a type of machine-readable code that contains information (i.e., information pertaining to a payment transaction). A typical QR code 102 may use four standardized encoding modes (numeric, alphanumeric, byte/binary, and kanji) to efficiently store data.

As explained above, QR codes 102 can encode financial transaction data and other transaction security data. A QR code 102 can be used to initiate transaction activity. Two-way communication using QR codes 102 can also improve transaction security.

The QR code application device 100 allows a user 116 to provide a tip electronically using a mobile computing device 118. Specifically, a mobile computing device 118 of a user 116 is used to scan a QR code 102 that is associated with an account of a service individual 114. The mobile computing device 118 displays, to the user 116 of the mobile computing device 118, an interface for receiving a tip amount to provide to the service individual 114 for services rendered by the service individual 114 to the user 116. The tip amount is then received from the user 116. The QR code 102 and the tip amount are transferred to a server system to request the transfer of the tip amount from a user's account to the service individual's account that is associated with the QR code 102.

Further, the tip amount is transferred from a user's account to an account of a service individual 114 using a QR code 102 associated with the service individual 114. Account information for a service individual's account is received. Information identifying the service individual 114 is also received. An association between a QR code 102 and the service individual's account is generated. The QR code 102 is provided to the service individual 114 to allow the service individual 114 to display the QR code 102 to a user 116 to whom the service individual 114 provides services. Once the user 116 scans the QR code 102 using a portable computing device 118, the QR code 102 is received along with a tip amount to transfer from a user's account to the service individual's account. Then, the tip amount is transferred to the service individual's account.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Further, computer storage media (devices) include RAM, ROM, EEPROM, CD-ROM, solid state drives (“SSDs”) (i.e., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, etc.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

In one embodiment, a service individual 114 wears a nametag 112 or carries a coffee cup 106 that includes a two-dimensional barcode (QR code 102). Other types of scannable codes could also be used in the same manner as the QR code 102. The QR code 102 is uniquely associated with the service individual 114. More specifically, the QR code 102 can uniquely identify a bank account of the service individual 114. In this manner, by scanning the QR code 102, an application executing on a smartphone 118 can retrieve the necessary information for transferring a tip from a user's account to the service individual's bank account.

Furthermore, a database of QR codes can be maintained (i.e., on a server system with which a smartphone 118 can communicate). Each of the QR codes 102 in the database can be associated with a unique individual. The database can also store account information for each of the service individuals 114. In such cases, when a user 116 scans a QR code 102 with a smartphone 118, an application 100 on the smartphone 118 can access the database to identify whether the QR code 102 is defined in the database. If the QR code 102 is defined in the database, the account information associated with the QR code 102 can be used to initiate the transfer of a tip from the user's account to the account associated with the QR code 102.

Additionally, each QR code 102 represents a unique identifier. When the QR code 102 is scanned, the unique identifier for the QR code 102 can be determined and used to query a data structure to obtain the account information associated with the QR code 102. Once obtained, the account information can be used to transfer a tip from the user's account to the account associated with the scanned QR code 102.

Furthermore, the present invention enables any service individual 114 to receive tips electronically by simply wearing or providing access to a QR code 102 that has been associated with the service individual 114 and the service individual's bank account (or other similar account). In some embodiments, the present invention can provide a website or other application where a service individual 114 can input their account information to receive a QR code 102 that can be used to receive tips. For example, in response to receiving a service individual's account information (i.e., bank account and routing number), the application can generate an association between the account information and a QR code 102. The associated QR code 102 can then be provided to the service individual 114. For example, the QR code 102 can be displayed to allow the service individual 114 to print it. In some embodiments, the QR code 102 can be printed as a sticker that can be adhered to a service individual's nametag 112, coffee cup 106, napkin 108, or other item. In this way, the QR code 102 will be visible to users 116 whom the service individual 114 assists thereby informing the users 116 that the service individual 114 accepts tips electronically.

The present invention can also store account information for users 116 that may use their smartphones 118 to tip a service individual 114. For example, a user 116 can input their bank account information or credit or debit card number which can then be stored for automatic retrieval when the user 116 scans a QR code 102. In this manner, the user 116 does not need to input this information when providing a tip. In some embodiments, the user 116 can also input a default tip amount so that when a QR code 102 is scanned, the default amount can automatically be transferred without requiring any input from the user 116. In other embodiments, after scanning a QR code 102, the user 116 can be presented with the option to specify or select an amount to tip.

In one embodiment, the QR code application device 100 comprises a plurality of indicia 120. The specific item 104 of the device 100 may include advertising, trademark, other letters, designs, or characters, printed, painted, stamped, or integrated into the specific item 104, or any other indicia 120 as is known in the art. Specifically, any suitable indicia 120 as is known in the art can be included, such as, but not limited to, patterns, logos, emblems, images, symbols, designs, letters, words, characters, animals, advertisements, brands, etc., that may or may not be QR code, service, or brand related.

As shown in FIG. 4, an example computer environment 400 includes a mobile computing device 118 which may typically be a smartphone having a camera with which a QR code 102 can be scanned. The mobile computing device 118 is interconnected via a network 402 with multiple server systems 404. The server systems 404 can represent the systems where a user's and a service individual's account information is stored as well as possibly other systems that are employed to perform a transfer of funds between accounts.

The specific manner in which funds are transferred between two accounts is not essential to the invention. The network 402 typically will be the internet although other networks can also be employed. For example, in a typical implementation, the mobile computing device 118 will communicate with one or more of the server systems 404 using a Wi-Fi or cellular (i.e., 4G) connection. Also, although this specification will primarily refer to using a smartphone to tip a service individual 114, any mobile computing device 118 capable of performing the described functionality could also be used (i.e., a tablet).

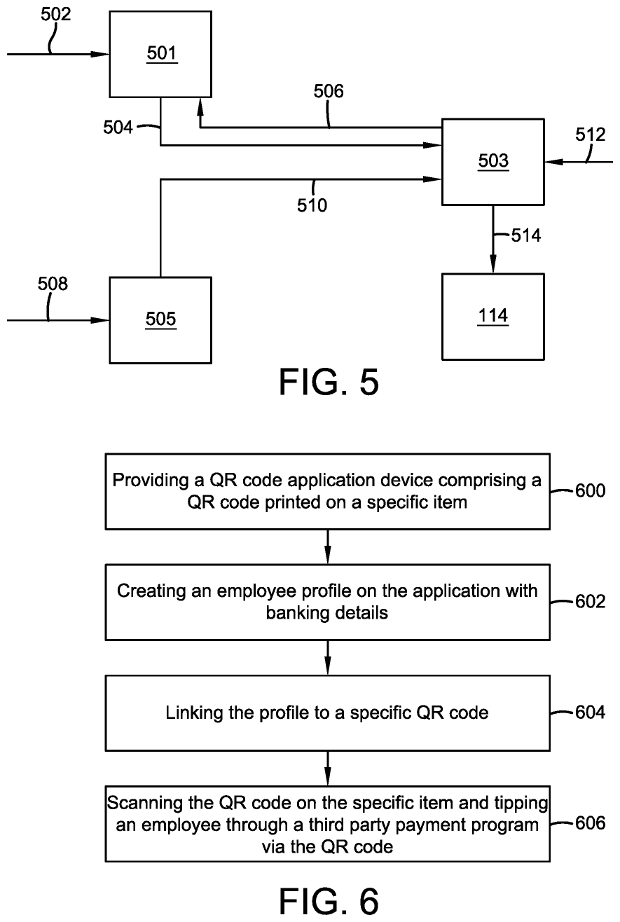

As shown in FIG. 5, a process 500 of creating an association between a QR code 102 and a service individual's account information and then using this association to transfer a tip to the service individual's account is disclosed.

A service individual desiring to receive a QR code inputs their account information (step 502). Account information can include a bank account number and a routing number as well as any other information necessary to transfer funds to the service individual's account. Additional information can also be input such as the service individual's name, work location, work title, picture, etc. Such information can be useful for providing an interface such as user interface when a QR code is scanned. The user computing system 501 can represent any device that a user can employ to provide information to server system. For example, user computing system 501 can be a smartphone having a custom app or a web browser that receives a service individual's account information or a desktop, laptop, tablet, or other computer that employs a browser or other application for receiving the account information.

Once the account information is input to a user computing system 501, the account information can then be sent to a server system 503 (step 504). The QR code can then be generated/associated with the account information (step 506). Once the service individual receives the QR code, it can be displayed (i.e., electronically or by printing the QR code) where users can view and scan it to provide a tip. Accordingly, a user scans the QR code using a smartphone 505 and inputs a tip amount (step 508). The scanned QR code, as well as the tip amount, are transmitted to a server system 503 (step 510). Then, the tip amount can be transmitted to the server system 503. The QR code is then used to retrieve the appropriate account information (step 512). Finally, the account information is used to initiate the transfer of the tip amount from the user's account to the account associated with the scanned QR code (step 514).

Accordingly, the present invention provides a simple manner for providing a tip to a service individual 114. The present invention would require the service individual 114 to wear (or otherwise present) a scannable QR code 102. The users 116 would then be tasked with scanning the QR code 102 and completing the tip transaction. The simplicity of the system 500 is therefore ideal for use by a service individual 114 who may not be able to take the time to process a transaction after performing each service, while also minimizing the steps required of the user 116 to provide the tip.

FIG. 6 illustrates a flowchart of the method of utilizing a QR code to tip an employee after service. The method includes the steps of at 600, providing a QR code application device comprising a QR code that is printed on specific items, such as cups, napkins, containers, etc. The method also comprises at 602, creating an employee profile on the application with banking details. Further, the method comprises at 604, linking the employee profile to a specific QR code. Finally, the method comprises at 606, scanning the QR code on the specific item and tipping a specific employee through a third-party payment program via the QR code.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “QR code application device”, “QR code device”, “application device”, and “device” are interchangeable and refer to the QR code application device 100 of the present invention.

Notwithstanding the foregoing, the QR code application device 100 of the present invention can be of any suitable size and configuration as is known in the art without affecting the overall concept of the invention, provided that it accomplishes the above-stated objectives. One of ordinary skill in the art will appreciate that the QR code application device 100 as shown in FIGS. 1-6 are for illustrative purposes only, and that many other sizes and shapes of the QR code application device 100 are well within the scope of the present disclosure. Although the dimensions of the QR code application device 100 are important design parameters for user convenience, the QR code application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A QR code application device that helps incentivize service industry employees to uphold good customer service, the QR code application device comprising:
a QR code;
a software application; and
a mobile computing device;
wherein the QR code is printed on a specific item to display;
wherein a service individual creates a profile on the software application, which is linked to the QR code; and
further wherein users tip the service individual electronically using the mobile computing device via the QR code printed on the specific item.

2. The QR code application device of claim 1, wherein the specific item is a cup, a napkin, a container, or a nametag.

3. The QR code application device of claim 2, wherein the mobile computing device is a smartphone.

4. The QR code application device of claim 3, wherein the smartphone is configured with an application that scans the QR code that is placed on the specific item.

5. The QR code application device of claim 4, wherein the QR code uniquely identifies the service individual including a service individual's account.

6. The QR code application device of claim 5, wherein the software application is configured with a user's payment account information to enable the QR code application to initiate transfer of a tip from a user's payment account to the service individual's account when the QR code is scanned.

7. The QR code application device of claim 6, wherein the user only needs to scan the QR code to provide a tip to the service individual.

8. The QR code application device of claim 7, wherein once the user scans the QR code using the smartphone, the QR code is received along with a tip amount to transfer from the user's account to the service individual's account; then, the tip amount is transferred to the service individual's account.

9. The QR code application device of claim 8, wherein the smartphone is interconnected via a network with multiple server systems, and further wherein the multiple server systems store a user's account information, a service individual's account information, as well as are employed to perform a transfer of funds between accounts.

10. A method of creating an association between a QR code and a service individual's account information and then using this association to transfer a tip to the service individual's account, the method comprising the following steps:
inputting a service individual's information;
sending account information to a server system;
generating a QR code with the account information; and
displaying the QR code, such that users can view and scan the QR code for tips.

11. The method of claim 10, wherein account information includes a bank account number and a routing number to transfer funds to the service individual's account.

12. The method of claim 11, wherein a user computing system includes a smartphone having a custom app or a web browser or a desktop, laptop, tablet, or other computer that employs a browser.

13. The method of claim 10 further comprising the following steps:
scanning the QR code and inputting a tip amount;
transmitting the scanned QR code and a tip amount to a server system;
using the QR code to retrieve appropriate account information; and
transferring the tip amount from the user's account to the service individual's account associated with the scanned QR code.

14. The method of claim 13, wherein the QR code is scanned using a mobile computing device.

15. The method of claim 13, wherein the service individual is required to wear or present a scannable QR code to users.

16. The method of claim 15, wherein the users would then be tasked with scanning the QR code.

17. The method of claim 16, wherein the users would then complete the tip transaction via a user interface.

18. The method of claim 17, wherein the method would be used by a service individual who is not able to take time to process a transaction after performing a service.

19. The method of claim 18, wherein the method minimizes steps required for the user to provide a tip for a service individual.

20. A method of utilizing a QR code to tip an employee after service, the method comprising the following steps:
providing a QR code application device comprising a QR code that is printed on specific items, such as cups, napkins, or containers;
creating an employee profile on the application with banking details;
linking the employee profile to a specific QR code; and
scanning the QR code on the specific item and tipping a specific employee through a third-party payment program via the QR code.
